(19) United States
(12) Patent Application Publication
(10) Pub. No.: US 2010/0088154 A1
(43) Pub. Date: Apr. 8, 2010

(54) SYSTEMS, METHODS AND COMPUTER PROGRAM PRODUCTS FOR COMPUTING AND OUTPUTTING A TIMELINE VALUE, INDICATION OF POPULARITY, AND RECOMMENDATION

(76) Inventors: Aditya Vailaya, San Jose, CA (US); Jiang Wu, Union City, CA (US); Robert Lincoln Lewis, JR., Los Gatos, CA (US); Vipin Jain, Santa Clara, CA (US); Manish Rathi, Palo Alto, CA (US); Min Sang Kim, San Jose, CA (US); Jeffrey Ronne, Cupertino, CA (US)

Correspondence Address: Zilka-Kotab, PC, P.O. BOX 721120, SAN JOSE, CA, 95172-1120, US

(21) Appl. No.: 12/569,668

(22) Filed: Sep. 29, 2009

Related U.S. Application Data
(60) Provisional application No. 61/103,092, filed on Oct. 6, 2008.
(60) Provisional application No. 61/186,761, filed on Jun. 12, 2009.

(51) Int. Cl. G06Q 10/00; G06Q 30/00; G06N 5/02

(52) U.S. Cl. 705/10; 705/14.49; 706/54

(57) ABSTRACT

A computer-implemented method is provided for computing and outputting a timeline value. In use, model data about a product is received. Additionally, thresholds relevant to the model data are received or computed. Further, a timeline value is computed based on comparing the thresholds to the model data, where the timeline value is indicative of a current stage in a lifecycle of the product. Further still, the timeline value is output. Additional systems, methods and computer program products are also implemented. For example, methods are presented for computing and outputting an indication of product buzz and/or popularity. Other methods include using one or more of timeline, popularity, sentiment, value, discount ratings, etc. to compute a recommendation and output the same.

### RELATED APPLICATIONS

The present application claims priority of provisional applications filed Oct. 6, 2008 under Application No. 61/103,092; and Jun. 12, 2009 under Application No. 61/186,761; which are incorporated herein by reference in their entirety for all purposes.

### FIELD OF THE INVENTION

The present invention relates to generating information, and more particularly to generating information based on calculations involving predetermined data.

### BACKGROUND

Many times, today's product information presentations fall into two categories: simple and detailed. In the simple category, a user is typically given a product image, short description, and price. In the detailed category, the user is often given a lot of reviews, specs, and discussions to read. However, current product information fails to address some of the basic questions in user's mind related to product purchases, such as the lifecycle evaluation or obsolescence of a product (e.g., is this product going to be obsolete soon), change in the sentiment about a product or the buzz, or determination of the right time to buy a product. Additionally, consideration of such elements is lacking from product recommendation determinations.

There is thus a need for addressing these and/or other issues associated with the prior art.

### SUMMARY

A computer-implemented method is provided for computing and outputting a timeline value. In use, model data about a product is received. Additionally, thresholds relevant to the model data are received or computed. Further, a timeline value is computed based on comparing the thresholds to the model data, where the timeline value is indicative of a current stage in a lifecycle of the product. Further still, the timeline value is output.

In addition, a computer-implemented method is provided for determining a popularity of a product, in accordance with another embodiment. In use, at least one parameter value for a product is received or computed for a first period of time, where the at least one parameter value includes at least one of a number, content, or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; and velocity of the product through the sales channel. Additionally, at least one normalized parameter value is received or computed for a category of the product for a second period of time. Further, it is determined whether the at least one parameter value for the product is above or below the at least one normalized parameter value for the category by a threshold amount. Further still, an indication is output that the at least one parameter value for the product is above or below the at least one normalized parameter value for the category by the threshold amount.

Further, a computer-implemented method is provided for generating a product recommendation, in accordance with yet another embodiment. In use, at least one of a timeline value that is indicative of a current stage in a lifecycle of a product; a product price value; a product sentiment value, a product popularity value; and a product discount value is received or computed. Additionally, a recommendation value is computed for the product based on the at least one of the timeline value; the product price value; the product sentiment value, the product popularity value; and the product discount value. Further, the indication of the recommendation value is output.

Other aspects, advantages and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a computer-generated method for computing and outputting a timeline value, in accordance with one embodiment.

FIG. 4 shows a computer-generated method for determining a popularity of a product, in accordance with another embodiment.

FIG. 5 shows a computer-generated method for generating a product recommendation, in accordance with yet another embodiment.

FIG. 6 shows an illustrative graphical presentation of a product review page, in accordance with another embodiment.

FIG. 7 shows an illustrative example of a display for multiple discounts, in accordance with another embodiment.

FIG. 8 illustrates an exemplary model timeline conceptual data model, in accordance with one illustrative embodiment.

FIG. 9 illustrates an exemplary logical data model, in accordance with one illustrative embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

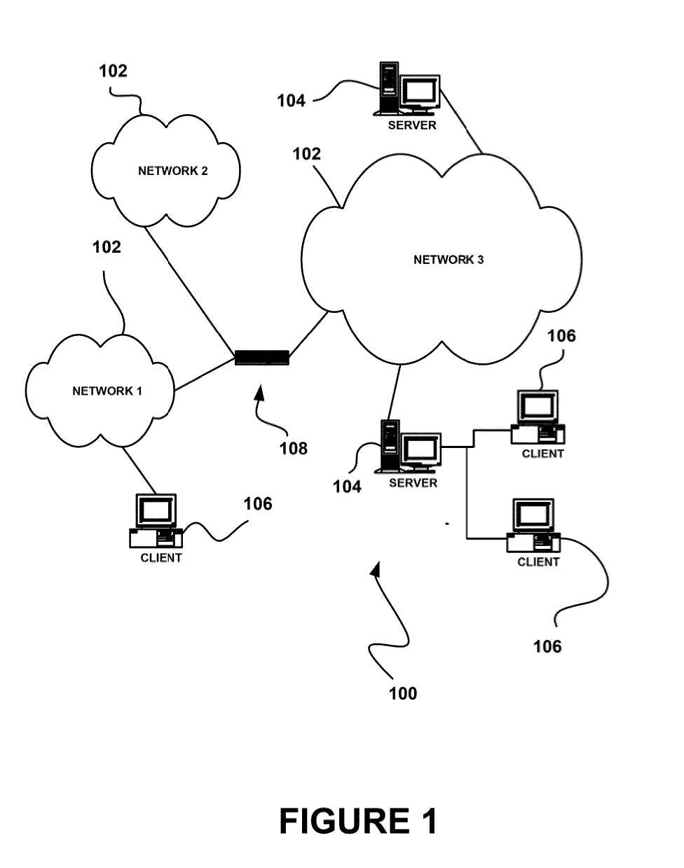

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

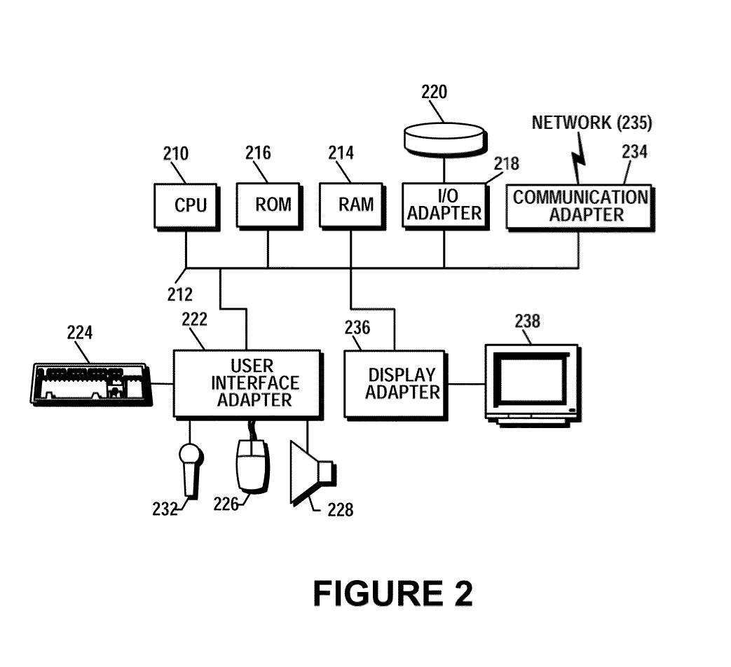

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

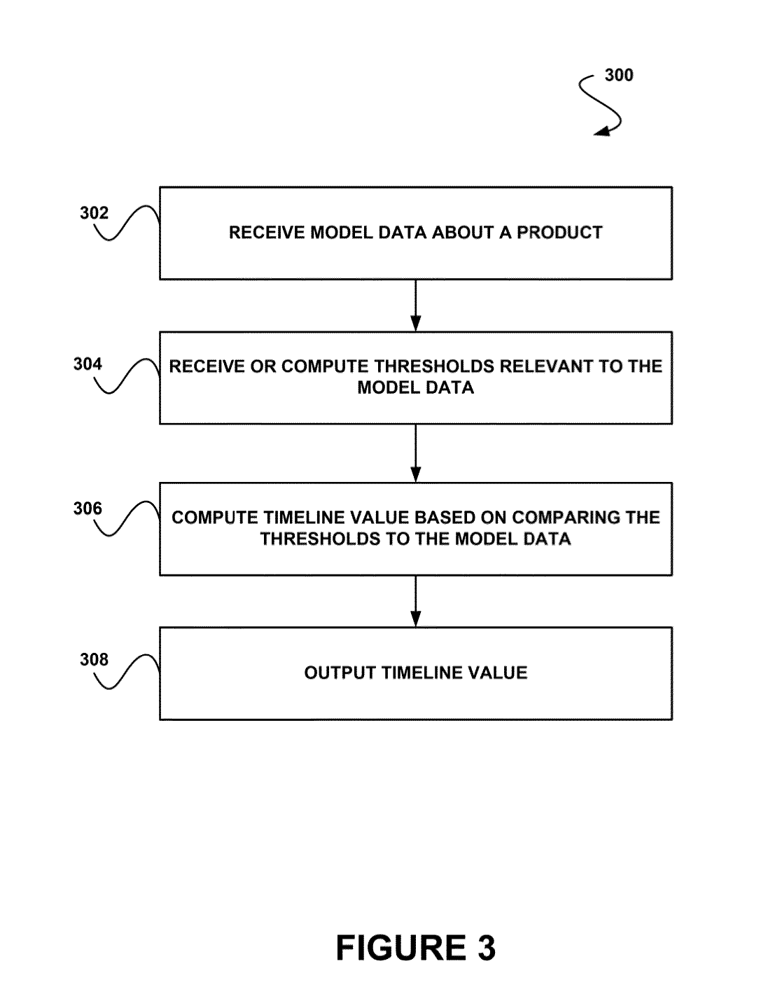

FIG. 3 shows a computer-generated method 300 for computing and outputting a timeline value, in accordance with one embodiment. As an option, the method 300 may be carried out in the context of the architecture and environment of FIGS. 1 and/or 2. Of course, however, the method 300 may be carried out in any desired environment.

As shown in operation 302, model data about a product is received. Additionally, as shown in operation 304, thresholds relevant to the model data are received or computed. Further, as shown in operation 306, a timeline value is computed based on comparing the thresholds to the model data, where the timeline value is indicative of a current stage in a lifecycle of the product. Further still, as shown in operation 308, the timeline value is output.

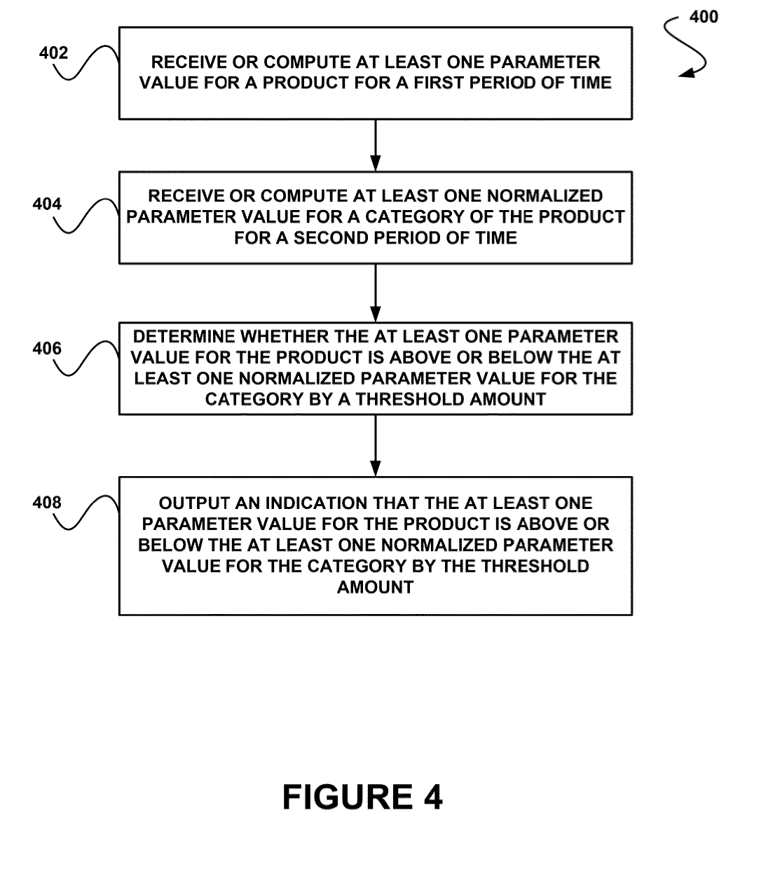

FIG. 4 shows a computer-generated method 400 for determining a popularity of a product, in accordance with another embodiment. As an option, the method 400 may be carried out in the context of the architecture and environment of FIGS. 1-3. Of course, however, the method 400 may be carried out in any desired environment.

As shown in operation 402, at least one parameter value for a product is received or computed for a first period of time, where the at least one parameter value includes at least one of a number, content, or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; a velocity of the product through the sales channel (e.g., change in the number of sellers carrying a product); etc. Additionally, other parameter values may be set forth herein.

Additionally, as shown in operation 404, at least one normalized parameter value is received or computed for a category of the product for a second period of time. Further, as shown in operation 406, it is determined whether the at least one parameter value for the product is above or below the at least one normalized parameter value for the category by a threshold amount.

Further still, as shown in operation 408, an indication is output that the at least one parameter value for the product is above or below the at least one normalized parameter value for the category by the threshold amount.

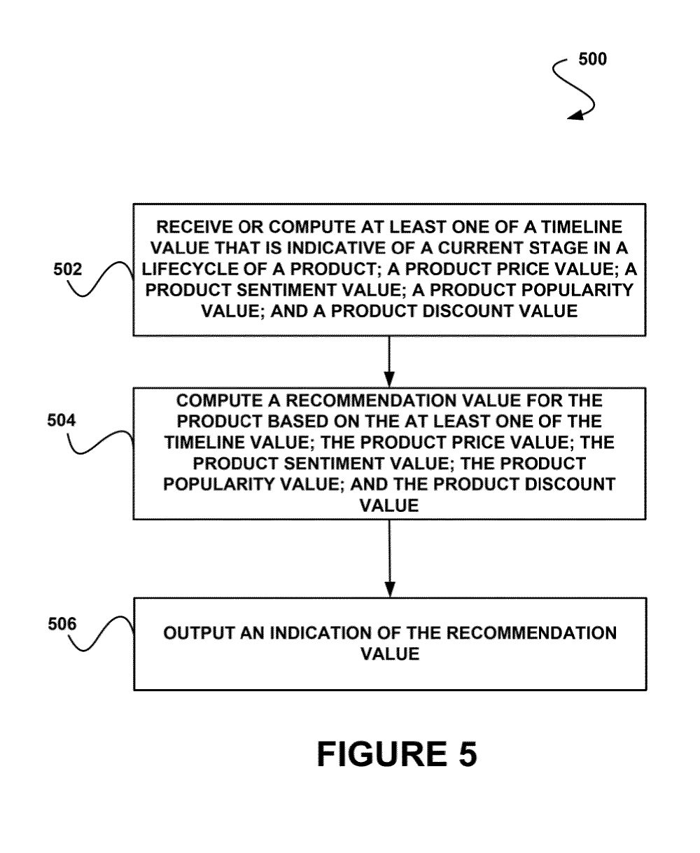

FIG. 5 shows a computer-generated method 500 for generating a product recommendation, in accordance with yet another embodiment. As an option, the method 500 may be carried out in the context of the architecture and environment of FIGS. 1-5. Of course, however, the method 500 may be carried out in any desired environment.

As shown in operation 502, at least one of a timeline value that is indicative of a current stage in a lifecycle of a product; a product price value; a product sentiment value, a product popularity value; and a product discount value is received or computed. Additionally, as shown in operation 504, a recommendation value is computed for the product based on the at least one of the timeline value; the product price value; the product sentiment value, the product popularity value; and the product discount value. In addition, as shown in operation 506, the indication of the recommendation value is output.

In the context of the present description, the model data may include any data that is associated with the product. For example, the model data may include at least one of user review data, store data, model introduction time data, price data, and buyer data of the product. In one embodiment, the user review data may include one or more indicators as to how people are talking about the product. Additionally, illustrative buyer data may include a number of purchases or buyers of the product.

Additionally, in one embodiment, the thresholds may be received from a vendor, a search result, a research entity, etc. For example, the thresholds may be received online, from a business partner, through a marketplace, etc. In another embodiment, the thresholds may be computed based on at least one of a category of the product (e.g., a subcategory of the product, a family of the product, etc.), a vendor or manufacturer of the product, and data about a family of the product. In yet another embodiment, the thresholds may be computed using a moving average of at least one of user review data, store data, model introduction time data, price data, and buyer data.

Also, in one embodiment, a history of all products may be maintained, and a time range of the timeline may be computed automatically for a particular set of products based on the history. For example, point and shoot cameras may have an expected life of up to a year, whereas digital single lens reflex (DSLR) cameras may have an expected life of 3 years or more, and these differences in expected life may result in timelines of different time ranges for point and shoot cameras and DSLRs. Further, in one embodiment, the timeline may be based off an introduction time of the product. Further still, in another embodiment, the timeline value may be output as graphical image data, may be output to a database, etc. In addition, the timeline value may be output to a user device in response to a request therefor.

In another embodiment, computing the timeline value may include the use of a two-stage algorithm. For example, all members of a similar group of products (e.g. old, middle, new, etc.) may be analyzed together, and historical data for the group may be used to establish a norm, or trend, line. For example, one or more items of behavior (e.g., a number of stores carrying a product, a number of people writing reviews for a product, etc.) may be analyzed for each product when the product was considered new. Additionally, see, for example, U.S. patent application Ser. No. 11/963,684, filed Dec. 21, 2007, and U.S. patent application Ser. No. 12/062,393, filed Apr. 3, 2008, which are hereby incorporated by reference in their entireties, and which describe examples of analyzing and applying feature data, historical data and other data, as well as processing such data to generate comparative data of a product to other products in its category.

Additionally, the product for which the timeline value is desired may have data up to a certain time point. By analyzing the trend line for the members of a group of products similar to the product, a state of the product may be projected onto the trend line in order to determine at what point the product is at on the timeline. In one embodiment, this point may include the timeline value. In this way, the timeline value may be based on current data for the product as well as a current data mean for one or more groups to which the product is related and/or associated.

Furthermore, in one embodiment, an average may be calculated for a particular brand, for all brands, for a general category, for a sub-category, etc. As a result, a data set may be chosen that may provide results of the highest accuracy. In another example, all products within one or more groups that have lived through a determined life cycle may be selected, and for each product one or more parameters for each period of one or more life cycle stages may be determined (e.g., when the product was deemed new, what were the parameters for the product—the number of stores, sellers, buyers, reviews, etc.). In another embodiment, an average of all the parameters for each product within the one or more groups may be determined and used in computing the timeline value.

In yet another embodiment, computing the timeline value may include performing a training session where, given the aforementioned parameters, a function may be generated for each stage of the timeline. Additionally, retraining may be performed at periodic intervals (e.g., every week, month, year, etc.). Further, a classification step may then be performed, where the parameters of the product for which the timeline value is desired may be analyzed in order to determine which function it most closely resembles.

In still another embodiment, the timeline value may be a prediction noted on the timeline as an arrow, where the arrow lies on a historical average, the head of the arrow lies where the actual data associate with the product ends, and the head of the arrow points in the direction of a dotted line where the prediction associated with the product follows a dotted line associated with the historical average associated with the product.

Also, in another embodiment, one or more links may be provided along with the timeline value. For example, a link may be provided to a newer product, a product with one or more improved aspects over the current product, a vendor of the product, other related products, etc.

Additionally, it should be noted that any of the aforementioned operations may be performed using one or more hardware components. For example, the hardware may include a processor. Additionally, in another approach, the hardware may include a processor and an input/output (I/O) device.

Further still, in one embodiment, the at least one parameter value may be preselected by a user. In another example, the at least one parameter may be obtained from a table. Of course, however, the at least one parameter value may be received or computed in any manner.

Additionally, in one embodiment, the first and second periods of time may be about the same length. For example, the first and second periods of time may differ in length by less than a predetermined amount, where the amount is one or more hours, days, weeks, months, years, etc. Additionally, the category of the product may include a subcategory of the product, a family of the product, etc.

Also, in one embodiment, the threshold amount may be computed. In another embodiment, the threshold amount may be preselected by a user. In yet another embodiment, the threshold amount may be obtained from a table. Of course, however, the threshold amount may be obtained in any manner.

In addition, a seasonal adjustment may be applied when determining whether the at least one parameter value for the product is above or below the at least one normalized parameter value for the category by the threshold amount. For example, a relation of the period of time to a seasonal period may be determined, where the seasonal period may include holidays, seasons, etc., and at least one of the product parameter value and the normalized parameter value may be adjusted to account for this relation.

Further, in one embodiment, the at least one normalized parameter value for the category may be computed using a training step where an average/norm is calculated for all products in the category over the second period of time. In another embodiment, the training step may be performed on a constant interval, e.g. a daily basis, a weekly basis, etc.

Also, in another embodiment, a popularity, “buzz,” etc. may be indicated for the product if the parameter value for the product is above the at least one normalized parameter for the category by the threshold amount. Additionally, a lack of popularity, “negative buzz,” etc. may be indicated for the product if the parameter value for the product is below the at least one normalized parameter for the category by the threshold amount. In yet another embodiment, the indication may include an image on the timeline indicative of the popularity of the product. For example, a head of the arrow in the timeline may be a different color, appear to be surrounded by flames, etc. if the product is determined to be popular.

In this way, it may be determined whether the product has a high level of interest or activity relative to its history as related to a history of other products in the same category as the product. For example, it may be determined whether the level of activity associated with the product is greater that what the product as well as similar products would be generally getting at the stage in the product's timeline.

In one embodiment, the recommendation value may include an indication that the product is a strong buy, a poor buy, an intermediate buy, etc. Additionally, the recommendation value may be computed based on the timeline value; the product price value; the product sentiment value, the product popularity value; and the product discount value. Additionally, the recommendation value may be computed based at least on the timeline value, and may further comprise calculating the timeline value by receiving model data about a product, receiving or computing thresholds relevant to the model data, and computing the timeline value based on comparing the thresholds to the model data.

Additionally, in another embodiment, the recommendation value may be computed based at least on the product sentiment value, and the product sentiment value may be calculated as follows. In one embodiment, at least one parameter value for a product for a first period of time may be received or computed. For example, the at least one parameter value may be computed, preselected by a user, obtained from a table, etc.

Further, the at least one parameter value may include at least one of a number, content, or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; a velocity of the product through the sales channel (e.g., change in the number of sellers carrying a product); and other parameters set forth herein.

Further still, at least one normalized parameter may be received or computed for a category of the product for a second period of time. The category of the product may include a subcategory of the product, a family of the product, etc. Further still, it may be determined whether the at least one parameter value for the product is above or below the at least one normalized parameter value for the category by a threshold amount. The threshold amount may be computed, preselected by a user, obtained from a table, etc. Also, the product sentiment value may be generated based on the determining.

Also, in one embodiment, an indication that the product is a strong buy, a poor buy, and intermediate buy, etc. may by output. In one embodiment, the recommendation value may be sent to a third party, where the recommendation value may include the indication thereof. In another embodiment, the recommendation value may be output to a user device in response to a request therefor. Additionally, in one embodiment, the recommendation value may be syndicated to a vendor, partner, etc. in order to facilitate commerce/selling of the product.

Further, in another embodiment, a historical trend of a particular product's recommendation value may be tracked over time, and one or more notifications may be displayed if one or more predetermined criteria are met. For example, a product may be noted as a strong buy for a month, a year, etc. Additionally, in one embodiment, a user may tailor the computing of the recommendation value to account for a particular vendor that they like. Also, in one embodiment, a user may submit a product name and price, and the recommendation value may be determined for that product and price (e.g., whether the product is a “good deal” at that price, etc.). Further, a price recommendation may be provided for a product based on the product's data. For example, a fair/good value price may be estimated for a product that is not a fair/good value at present. This feature may be used to notify users the maximum price they should pay for the product for it to be a good deal as compared to all other products in its category, sub-category, etc.

Further, a price drop may be predicted for a product based on historical and current data for products in the same product category or subcategory. The set of discrete data values (lifecycle state, sentiment, buzz, value, price, velocity of reviews/news/blogs/merchants selling the product/product features) may be used to train a system to predict the price drops. Users can be alerted if a price drop is predicted to occur, which may allow them to hold off purchase until the price drop, dispose of owned products before the price drop, look for other products that may be a better deal, etc.

Additionally, a submission of a product subject to the computation of the recommendation value as well as the indication of the reputation value may be performed in any manner. For example, a product name may be submitted via a website, via Twitter™, via a mobile phone, etc. Additionally, the reputation value may be output on a printable information data sheet that could be printed and brought to a retail store, for example.

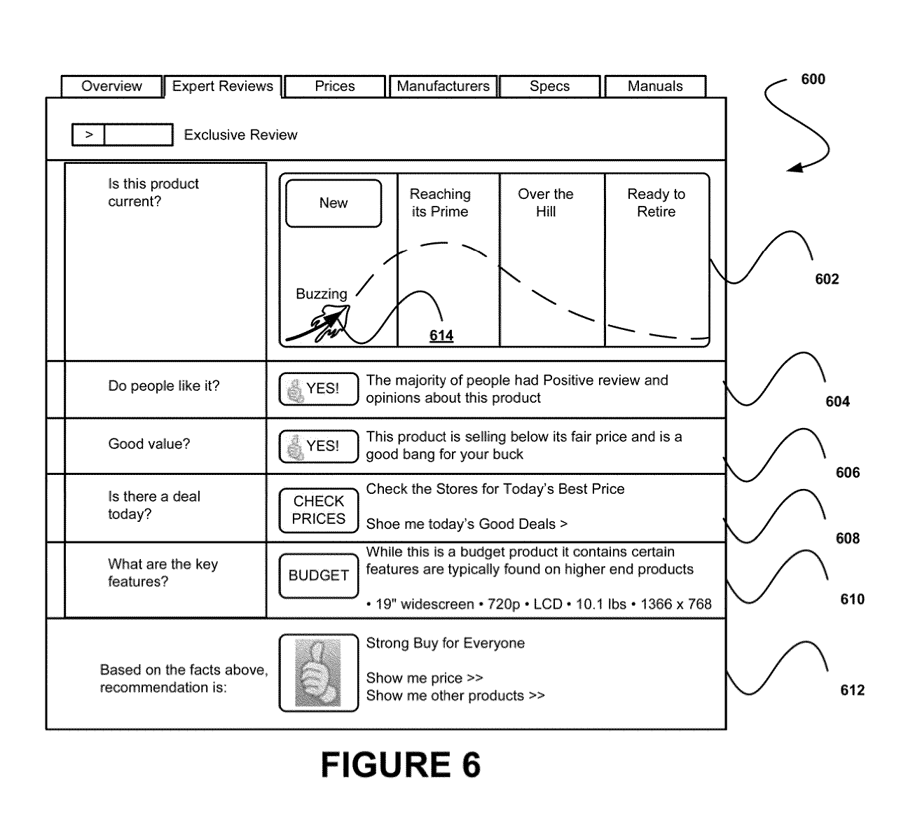

FIG. 6 shows an illustrative graphical presentation 600 of a product review page, in accordance with another embodiment. In one embodiment, graphical presentation 600 may be aimed at providing users with a concise and meaningful recommendation for a product (e.g., an electronics product, etc.). The graphical presentation 600 may be displayed in an electronic document, web page, etc. such as part of a “Product Fact Sheet,” for example, on a product review page on a website. The notion of creating a concise fact sheet and recommendation of a product may open up other avenues of display, such as on a mobile device, a web service such as Twitter™, a printed catalog, or any other display format. Additionally, the graphical presentation 600 may be based on various combinations of product data (also called product facts).

As shown, a product timeline 602 represents a current stage in a product's lifecycle. In one embodiment, the product timeline 602 may include one or more of the following states: New Product, Current Product, Previous Generation Product, and Older Product (retired and not selling). In another embodiment, the timeline value in the product timeline 602 for each product may depend on various data including a product introduction time, a product merchant data (e.g., store counts and prices, etc.), a number/content/velocity of expert and user reviews and ratings, a number/content of news and articles, blogs, forums regarding the product, etc.

Also, additional information such as various thresholds (‘rules’) and matching conditions applicable to a set of products in a category or sub-category may also be employed in the product timeline 602. These thresholds may be computed for vendors or brands based on the historical lifecycle of these brands. Additionally, these thresholds may also be computed for various types of products within a category. For example, an “SLR camera” type may have a different set of thresholds and a longer lifecycle until product retirement than a “point and shoot” camera type.

Further, an additional time-window may be applied to filter and select relevant data to compute a product's timeline in the product timeline 602. For example, a training step may be involved to compute the various thresholds and time-windows using historical data from a set of products in a category or sub-category. All these data may be combined to generate a single timeline value for a product in the product timeline 602.

Also, a product popularity 614 represents a current buzz around the product. In one embodiment, the product popularity 614 may be computed from processing the number, content, and velocity of expert reviews, user reviews, news, articles, blogs, and forums regarding the product on the web. Additional information such as various thresholds (e.g., “rules,” etc.) and matching conditions applicable to a set of products in a category or sub-category may also be employed in computing the product popularity 614 for a product.

Further, an additional time-window may be applied to filter and select relevant data to compute the “current” product popularity 614 for a product. A training step may be involved to compute the various thresholds and time-windows using historical data from a set of products in a category or sub-category. For example, the velocity of user reviews (e.g., rate of addition of reviews per day, etc.) for a product as compared against a historical median of user reviews for all products in that category or sub-category can be used to define a threshold for “buzzing” products. In another embodiment, positive, negative, and/or overall buzz may be computed for a product. The popularity score may be converted into a set of discrete values for use in a final recommendation 612.

Further still, in one embodiment, product popularity 614 may also be combined with the product timeline 602 to produce a set of discrete values that indicate product desirability and/or adoption. For example, an indication in the product timeline 602 that a product is “Reaching its prime” may indicate that the product has been through the new phase but still have lot of momentum behind it (e.g., from the perspective of sellers and velocity of buzz, reviews, etc). In addition, an indication in the product timeline 602 that a product is “Over the Hill” or “Losing Momentum” may indicate that the product is no longer new and is decelerating in buzz, reviews etc.

Additionally, a product sentiment 604 represents the current community sentiment for a product. In one embodiment, the product sentiment 604 may be based on processing expert reviews, user reviews, news, articles, blogs, and forums regarding the product on the web. In another embodiment, a score associated with the product sentiment 604 may be converted into a set of discrete values for use in the final recommendation 612.

Also, a product price value 606 represents if a product is a value buy at a given price. In one embodiment, the product price value 606 may include a value computation as described in the U.S. patent application Ser. No. 11/963,684 filed Dec. 21, 2007 which has been incorporated by reference. In another embodiment, a value score associated with the product price value 606 may be based on a combination of product feature value and selling price, where the product feature value is based on how the features of a product stack in terms of features of other products in the product's category.

Additionally, in one embodiment, any attributes that can be associated with a product may be included in the product's features. These may include and are not limited only to the following: the manufacturer's specifications, age of product, buzz on the product, sentiment of the product, brand, sub-category of product, etc. The value score may be converted into a set of discrete values for use in the final recommendation 612.

Further, a product discount 608 may identify deals and price reductions for a product that are not due to product obsolescence. In one embodiment, the product discount 608 signal (or, for example, a product deal) may be based on the historical and current prices from one or more predetermined merchants. For example, if the current price for a product falls a predetermined amount (e.g., 5%, 10%, 15%, etc.) below a moving average (e.g., based on “n” days, based on one or more historical prices in a list over a predetermined time period, etc.) from a merchant and/or ASP from a plurality of merchants, this would indicate a product discount 608 for the product from a given merchant or plurality of merchants.

Additionally, in one embodiment, the product discount 608 may only identify deals and price reductions for a product from one or more predetermined vendors. For example, the product discount 608 may only identify deals and price reductions for a product from one or more vendors determined to be trusted (e.g., on a list of rated/trusted merchants, etc.). Further, in another embodiment, a link to a purchase page may be provided under the product discount 608 in order to promote a user to click through to purchase the product.

In yet another embodiment, a user may select one or more stores that they are interested in, and may be alerted by the product discount 608 only when deals and price reductions for a product exist for those stores. Also, in one embodiment, if a price reduction becomes permanent, the product may no longer be flagged by the product discount 608 as a deal over time. Further, one or more elements of the product discount 608 may be used in the calculation of the product timeline 602. For example, the product discount 608 may note that manufacturers are attempting to sell a particular product in bulk, or are putting the product on clearance, or are spiking the price in response to the product's obsolescence, and this may be utilized by the product timeline 602 in moving the product to a different state.

In addition, the product discount 608 may identify deals and price reductions for a product on a predetermined schedule (e.g., once a day, once an hour, once a week, etc.).

In one embodiment, this data may differ from the product price value 606 in that a product may be selling at a discount, but may still not be a good value and there may be products that are good values, but may not have had a price reduction in the recent past and hence may not be marked with a product discount 608. In another embodiment, the product discount 608 may also be based on comparing current prices from each of the top merchants relative to a moving average of price (ASPs) from the top merchants. For example, any period of time may be selected to trigger the product discount 608, such as 14-day or 30-day period.

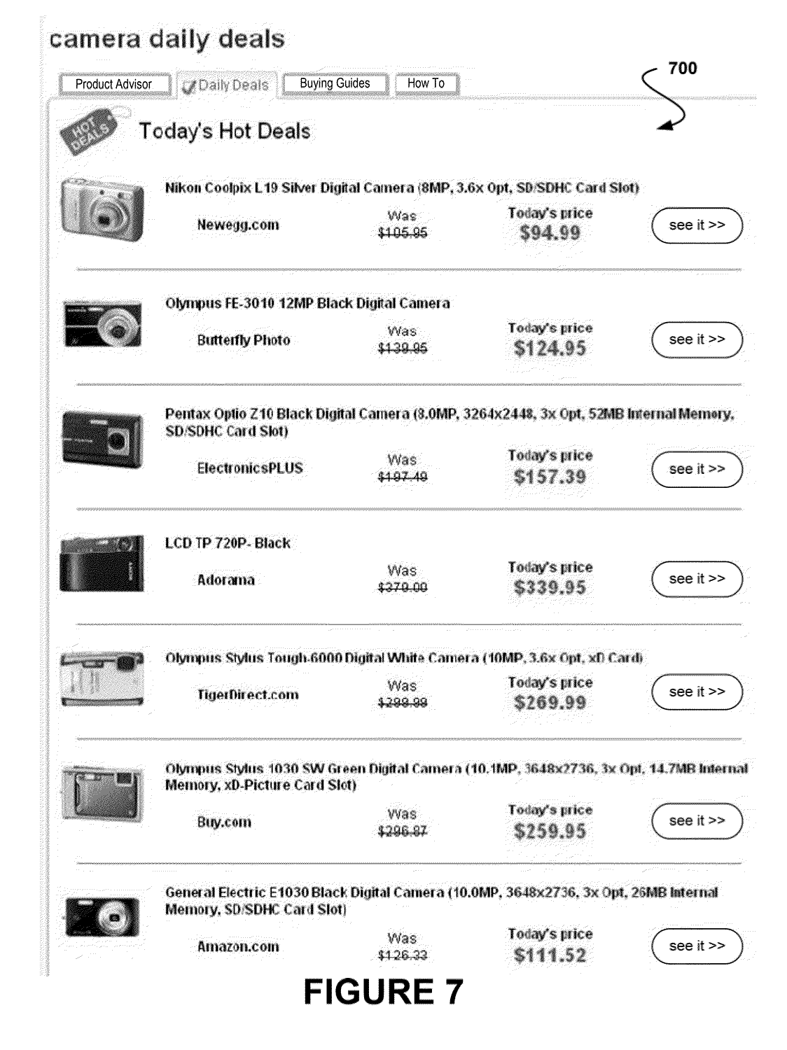

Additionally, in one embodiment, a product may also have multiple product discounts 608, one for each of the top merchants showing the discount. See FIG. 7 for an illustrative example of a display 700 for multiple discounts, in accordance with another embodiment. In another embodiment, all merchant discounts for a product may be combined to a single discount score associated with the product discount 608 for a product. The product discount 608 may be converted into a set of discrete values for use in the final recommendation 612.

Further, a final recommendation 612 is the result of a computation process that may take as input some or all the facts associated with a product, such one or more of the aforementioned components of the graphical presentation 600. In one embodiment, the computation process computes a concise and meaningful final recommendation 612 for the product. For example, the final recommendation 612 may include a statement regarding the product, for example, that the product is a “Strong Buy for Everyone.”

In one embodiment, the final recommendation 612 may be calculated using the product timeline 602, the product popularity 614, the product sentiment 604, the product price value 606, the product discount 608, and a product key features element 610, which illustrates one or more key features of the product. For example, each of the aforementioned elements may be simplified to one or more basic values (e.g., a “thumbs up” position, one of four stages, etc.). Additionally, the combination of these basic values for each element may be determined for a particular product, and the final recommendation 612 may be based off the combination. In this way, determining a final recommendation 612 may be simplified and expedited by using a finite number of possible basic values instead of a more complicated calculation involving more specific/complicated data.

Additionally, with respect to the product sentiment 604, the product price value 606, and the product key features element 610, see, for example, U.S. patent application Ser. No. 11/963,684, filed Dec. 21, 2007, which has been incorporated by reference, and which describes examples of displaying product information.

Business Applications

One or more embodiments disclosed herein provide the opportunity to expand beyond simply recommending or not recommending specific products. In one embodiment, one or more embodiments may also recommend alternative products to users should a product not meet the requirements they were seeking. For example, if the product is over the hill or later and the user was interested in a newer product, a recommendation service may suggest alternative products that are similar or better in features and functionality for around the same price or less. A reference to any replacement products from the same brand manufacturer that may have superseded the original products may also be included in the recommendation.

While it's common for retailers to promote new products so users can find them easily, none offer the ability for users to shop for products in other stages of their life beyond new. One or more embodiments disclosed herein enable users to shop by the life stage of a product. For example, users may shop for products that are over the hill if they happen to be interested in finding bargains on many of the previous years' top products.

Other business applications are also possible. Several illustrative business applications follow. Note that a “decision” in any of the following paragraphs of this section may instead be embodied as a recommendation for or against one or more of the possible options of the decision. Methodology disclosed herein may be used to generate and output such a recommendation, as will be apparent to one skilled in the art.

In one embodiment, product decisions may be made based on the lifecycle stage of a product. For example, some people want to buy new and trendy products while some people want to buy good bargains that they might find in products over the hill or ready to retire.

In another embodiment, product decisions may be made based on the buzz about a given product. This may be particularly so when the buzz indicates start of a new trend.

In yet another embodiment, product decisions may be made based on a special bargain price at a retailer.

In a further embodiment, product decisions may be made based on value (e.g., good bang for the buck) and/or popularity.

In a yet further embodiment, a good time to buy a product may be determined. For example, the timing may be based on the product becoming a good value and/or having a bargain and/or becoming a favorable recommendation.

In another embodiment, upgrade decisions may be made based on the lifecycle stage of their existing products.

In yet another embodiment, disposal decisions may be made based on the lifecycle stage of their existing products. For example, one may decide to sell a product already owned when it starts to lose momentum to prevent accelerated erosion of value.

In a further embodiment, retailers and brands may make various offer packaging decisions about a product/product family based on the lifecycle stage of a product. For example, one may discount a specific product, or engage in group buying or bundled offering to clear the inventory when a product starts losing momentum.

In a yet further embodiment, retailers and brands may dynamically adjust product prices based on a current state of the recommendation and marketplace acceptance (e.g., positive sentiment and/or buzz and/or value and/or recommendation etc).

Generating Data for a Product Analysis

In one exemplary embodiment, every model that has a snapshot may have one or more data elements associated with it. One example of a data element is Product Timeline={pre-release, new, current, previous version, older}, where a product may be assigned only one product timeline value at a given time. Another example of a data element is Product Sentiment={up, average, down}, where a product may be assigned only one product sentiment value at a given time. Yet another example of a data element is Product Popularity={hot, not}, where a product may be assigned only one product popularity value at a given time. Additionally, another example of a data element is Buy Now={yes,no}, where if Buy Now is yes, then a merchant has a good deal on the product.

In another embodiment, the generation of a product analysis uses a set of data that may be automatically extracted and saved in a database. This data may be manually over-ridden in a timed manner, i.e., all manual over-rides may be maintained for a fixed time period only. In yet another embodiment, a product may move along the timeline in one direction only—e.g., a product may not be assigned “Current” after it has been assigned “Previous version,” etc.

Additionally, the product timeline may be computed from data elements including an introduction date, a number of stores (which may include a moving window), a median price (which may include a moving window), a moving window size, etc.

Some exemplary functions which may be used for calculating a product timeline are shown in Table 1 below. Additionally, it should be noted that certain corner case conditions may be used for products that are sold directly (may be very few stores), for example, Apple™ products, Dell™ products, etc.

TABLE 1
Pre-release = f(hasModel,hasStores,introDate,introTimeThreshold1)
New = f(hasIntroDate,hasSellers,introTimeThreshold2)
Current = f(hasIntroDate,maxAvgNumberOfSellers,curAvgNumberOfSellers,maxMedianPrice,curMedianPrice,introTimeThreshold3)
Previous Gen = f(hasIntroDate,maxAvgNumberOfSellers,curAvgNumberOfSellers,maxMedianPrice,curMedianPrice,introTimeThreshold3)
Older = f(hasStores,introTimeThreshold4)

Further, in one embodiment, a product sentiment value may be current. For example, the product sentiment value may include an average over one or more months. Additionally, in one embodiment, the product sentiment value may not change very frequently, thereby providing a dampening effect such that product is assigned a sentiment for at least a particular time period. Further, in another embodiment, all products within a category may be ranked in order based on sentiment, such that a percentage may be picked up easily if desired. Further still, a product sentiment value may be based on a rating in a window (e.g., a window of time, etc.), a number of reviews in the window, etc.

For example, the product sentiment may be “up” (e.g., relate to a “thumbs up” icon, etc.) if there are a particular number of reviews in the window and the average rating is greater than or equal to a particular high value (e.g., 4, 5, etc.). In another example, the product sentiment may be “average” (e.g., relate to a “sideways thumb” icon, etc.) if there are fewer than a particular number of reviews in the window, or if there are a sufficient amount of reviews in the window and the review average is between a high value and a low value (e.g., less than 4 but greater than or equal to 3, etc.). In yet another example, the product sentiment may be “down” (e.g., relate to a “thumbs down” icon, etc.) if there are a particular number of reviews in the window and the average rating is less than a particular low value (e.g., 1, 2, 3, etc.).

Additionally, in another embodiment, a product popularity value may be current (e.g., based on a number of the most recent months of data). The product popularity data may not change very frequently, and a dampening effect may occur such that a product may be assigned a popularity value for at least a determined time period. Further, all products within a category may be ranked in order based on popularity, such that a percentage may be picked up easily if desired.

Further, in still another embodiment, the product popularity value may be based on a number of user reviews or other reviews over a window including a predetermined number of months. Additionally, it may be preferable to have or acquire a per site breakdown of user reviews in the window. Further, the product popularity value may be based on a number of stores selling the product (e.g., for an average in a window of a predetermined number of months).

Also, it should be noted that certain corner case conditions may be used for products that are sold directly (may be very few stores), for example, Apple™ products, Dell™ products, etc. In another example, weight may be added to certain products' stores if the product is only sold at one store.

An exemplary function which may be used for calculating a product popularity is shown in Table 2 below.

TABLE 2
Hot = Hot Score in top P percentile in its category, where
Hot Score = f(growth of user reviews in window, total user reviews in
window, growth in number of stores in window, average number of stores
in window)

Model Timeline

This section outlines an exemplary process of storing threshold values and applying those thresholds to matching models in a system to compute model timeline values. This section also covers an exemplary embodiment that illustrates how overridden timeline values may affect the rest of the model timeline computation system.

In one embodiment, model timeline may be a sub-section of a Product Low-Down feature. One or more models in the system may be classified as new, current, previous, or older. In one embodiment, in order to determine the timeline value for each model, the model timeline computing system may have access to various data including model introduction time, store data, user review counts, etc. In addition to such model information, in another embodiment, various threshold sets (‘rules’) and matching conditions that have been defined by an external operator may be accessible to the timeline computation component. Therefore, a component of the model timeline system may provide interfaces for adding and updating such thresholds while another component may be responsible for obtaining and applying those thresholds during the computation of model timeline value for each model.

In one embodiment, every model may have one or more of the following data elements associated with it: Model timeline={new, current, previous version, older}. In another embodiment, a product may be assigned only one value at a given time.

Model timeline generation may use a set of model data, user review data, and store data that is read and saved in a database. Additionally, these data may be manually over-written, but in a timed manner (e.g., all manual over-rides may be maintained for a fixed time period only, etc.).

Further, in another embodiment, a product may move along the timeline in one direction only. For example, a product may not be assigned “Current” after it has been assigned “Previous version.” Further still, the model timeline may be computed from the following data elements: Intro date, Number of stores (moving window), Median price (moving window), Moving Window size, Rule sets that have been generated and retrieved from an external system, etc.

Exemplary moving functions are illustrated in Table 3. In another embodiment, certain corner case conditions may be used for products that are sold directly (e.g., in very few stores, etc.), such as Apple™ products and Dell™ products.

TABLE 3
Moving from New to Current = f(min intro time, max intro time, moving
avg. # of stores)
Moving from current to Previous = f(min intro time, max intro time,
moving avg. # of reviews)
Moving from Previous to Older = f(min intro time, moving avg. # of
stores)

In one embodiment, one or more precalculations must be performed. For example, a long term and short term moving average number of reviews for each model may be computed in another system, and such data may be consistent at the time of model timeline computation. Additionally, the definition of long term and short term moving average may be determined. Also, a moving average number of stores and its max for each model may be computed in another system, and such data may be consistent at the time of model timeline computation.

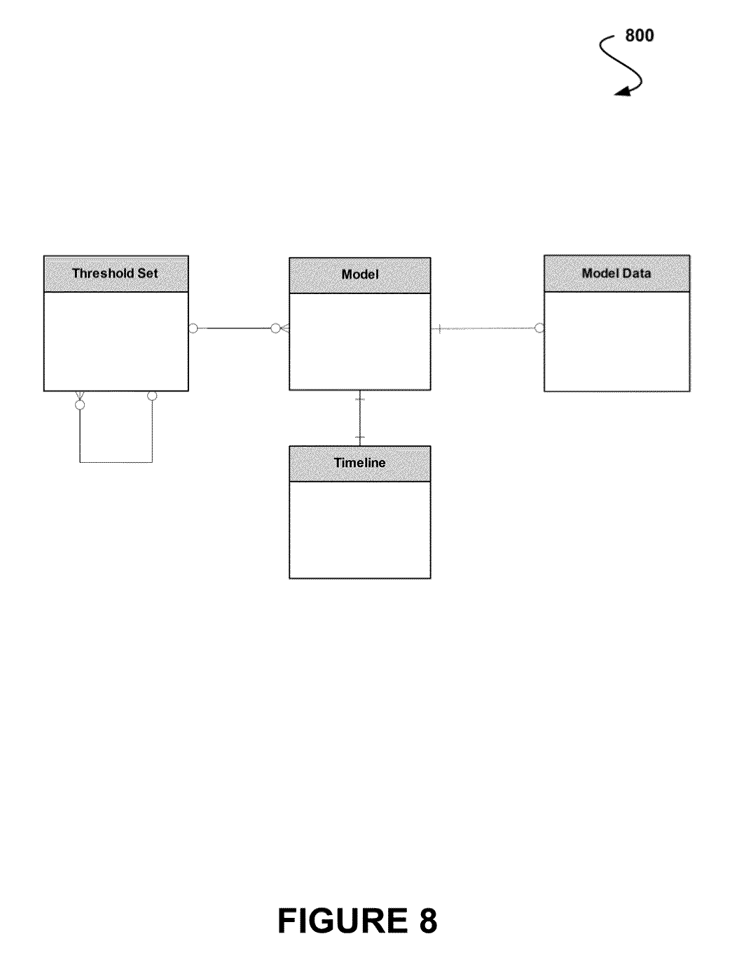

FIG. 8 illustrates an exemplary model timeline conceptual data model 800, in accordance with one illustrative embodiment. In one embodiment, in order to support external operator's input of new or updated threshold sets, a threshold set manager may be used. This component may be responsible for accepting data from an external data source (e.g., an ex. csv file, etc.), validating, and storing threshold sets. In addition, this component may be responsible for exporting the currently stored data into a data format which can be edited by an operator.

In another embodiment, when finding relevant threshold values for a given model with a valid snapshot, a model's category, vendor, and family data may be used for finding a matching threshold value set. For example, using the hierarchical data structure, only a single set of matching threshold values that match the given condition (e.g., category, vendor, family, etc.) may be returned per model. Additionally, each threshold value set may contain one or more threshold values for each model attribute (e.g., min introduction time=6 months:max introduction time=9 months:# of sellers>1, etc.). The matcher component may be responsible for applying these threshold values during computing the model timeline value for the model.

Further, in another embodiment, given a model with a valid snapshot, the matcher component may first retrieve the model timeline values that have been previously computed. In one embodiment, if the value has been manually overridden by an operator, then the computation step may be skipped. However, if there was no overridden timeline value, then the matcher component may be responsible for gathering relevant model data (e.g., store data, UR data, model introduction time, etc.) from different sources and query the threshold storage component for relevant set of thresholds. Once the model data and thresholds have been obtained, this component may compute the timeline value based on the thresholds and store the computed value via the timeline storage component.

Further still, in one embodiment, the timeline storage component may be separated from the matcher component since some of the timeline values may be manually overridden by an operator. This component may be responsible for providing the basic interfaces for an external operator to override the computed timeline value. The timeline storage component may also be responsible for providing the final timeline value to the rest of the system. Also, the final timeline value may be the computed timeline value if it was not manually overridden.

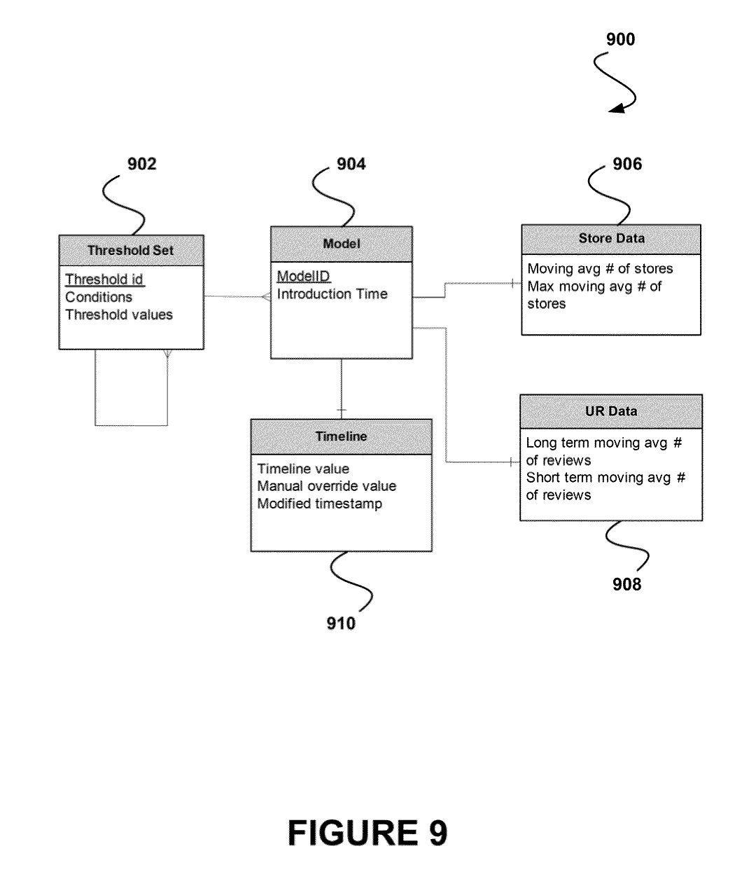

FIG. 9 illustrates an exemplary logical data model 900, in accordance with one illustrative embodiment. As shown, threshold set 902 includes a threshold ID. In one embodiment, no two threshold sets 902 may have the same threshold ID. Additionally, the threshold set 902 includes one or more conditions as well as threshold values. Further, the threshold set 902 may include or be associated with a parent threshold set as well as one or more models 904.

Further, model 904 includes a model ID. In one embodiment, no two models 904 may have the same model ID. Additionally, the model 904 includes an introduction time. Further still, the model 904 may include or be associated with one or more of store data 906, user review (UR) data 908, and timeline 910.

Also, store data 906 includes a moving average number of stores as well as a maximum moving average number of stores. Further, UR data 908 includes a long term and short term moving average number of user reviews. Timeline 910 includes a timeline value, a manual override value, and a modified timestamp.

Software Components

In one embodiment, external operators may define all threshold values and group them into relevant sets using category, vendor, and family conditions. While they are human readable externally, they may be stored via a threshold set manager component so that they can be retrieved during the match step. In one embodiment, the threshold set manager component may be responsible for importing new or updated threshold sets as well as exporting the current threshold sets into human readable data source for editing. Since the input data source may be manufactured by human operators, some data validations may be performed before adding or updating threshold values and conditions.

Additionally, during the model timeline computing step, the threshold set manager component may be asked to provide one or more sets of threshold values based on matching conditions. This component may return a single set of threshold values that matches the given condition. Using the hierarchical structure of the threshold data, most granular matching conditions may be qualified as the result set (e.g., ‘category & vendor & family’ matching condition may be better than ‘category & vendor,’ etc.).

Further, a threshold matcher component may be responsible for gathering all raw data such as model family, vendor, category, introduction time, and the number of recent user reviews for a given model. Using the model information, the threshold matcher component may request the threshold storage component to look up and provide a set of threshold values. In one embodiment, if matching threshold values are found, then the threshold matcher component may compute the model timeline using those thresholds. Additionally, computed timeline values may be stored via the timeline manager. In another embodiment, if the model timeline value has been overridden by an external operator, the threshold matcher component may skip the entire data gathering and computing step.

Also, a timeline manager component may provide a way to store the computed and manually set timeline values. While this component may provide both computed and manually overridden model timeline values (e.g., including the expiry date, etc.) to the threshold matcher component, in one embodiment, only the computed or manually overridden (if it exists) model timeline values may be visible to the rest of the system. In another embodiment, for the manual override interface, all values stored may be returned.

Runtime Data Flow

Table 4 illustrates exemplary inputs and outputs during runtime for various components described hereinabove.

TABLE 4
Threshold Set Manager
Input during threshold value updates - New or updated threshold values
from a human readable formatted data source generated and provided by
an external system.
Input during matching step - model information (matching conditions)
from the threshold matching component.
Output - One set of threshold values to the Threshold matcher component
during its matching step.
Threshold Matcher Component
Input during matching step -

Basic model information: introduction time and other model
conditions
Moving average # of stores, max moving average # of stores
Long term and short term moving average # of user reviews
Manually overridden value and last modified timestamp

Input during matching step -

Matching threshold values from Threshold Set Manager

Output - Timeline type (e.g. ‘pre-release’, ’new,’ etc.) into Timeline
Manager.
Timeline Storage
Input -

Computed timeline type for each model with a snapshot
If manually overridden by an operator, then the override timeline type
value and the override expiry time/date from a manual override
interface

Output - For manual override, currently set product time values,
overridden values, and expiry dates.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system (e.g., where the steps are executed by a processor), or implemented in hardware utilizing either a combination of microprocessors or other specially designed application specific integrated circuits, programmable logic devices, or various combinations thereof. In particular, methods described herein may be implemented by a series of computer executable instructions residing on a physical storage medium such as a disk drive, computer readable medium, etc. In other approaches, methods described herein may be implemented by a series of computer executable instructions residing on a non-physical storage medium such as a carrier wave. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

Embodiments of the invention can also be provided in the form of a computer program product comprising a computer readable medium having computer code thereon. A computer readable medium can include any medium, preferably a physical medium, capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
receiving model data about a product;
receiving or computing thresholds relevant to the model data;
computing a timeline value based on comparing the thresholds to the model data, the timeline value being indicative of a current stage in a lifecycle of the product; and
outputting the timeline value.

2. The method of claim 1, further comprising computing the thresholds based on at least one of a category of the product, a vendor or manufacturer of the product, and data about a family of the product.

3. The method of claim 1, wherein the model data includes at least one of user review data, store data, model introduction time data, price data, and buyer data of the product.

4. The method of claim 1, wherein the thresholds are computed using a moving average of at least one of user review data, store data, model introduction time data, price data, and buyer data.

5. The method of claim 1, wherein the timeline value is output to a user device in response to a request therefor.

6. A computer program product embodied on a computer readable medium, comprising:
computer code for receiving model data about a product;
computer code for receiving or computing thresholds relevant to the model data;
computer code for computing a timeline value based on comparing the thresholds to the model data, the timeline value being indicative of a current stage in a lifecycle of the product; and
computer code for outputting the timeline value.

7. A system, comprising:
hardware for receiving model data about a product;
hardware for receiving or computing thresholds relevant to the model data;
hardware for computing a timeline value based on comparing the thresholds to the model data, the timeline value being indicative of a current stage in a lifecycle of the product; and
hardware for outputting the timeline value.

8. A computer-implemented method, comprising:
receiving or computing at least one parameter value for a product for a first period of time, wherein the at least one parameter value includes at least one of a number, content, or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; and velocity of the product through a sales channel of the product;
receiving or computing at least one normalized parameter value for a category of the product for a second period of time;
determining whether the at least one parameter value for the product is above or below the at least one normalized parameter value for the category by a threshold amount; and
outputting an indication that the at least one parameter value for the product is above or below the at least one normalized parameter value for the category by the threshold amount.

9. The method of claim 8, wherein the first and second periods of time are the about same length.

10. The method of claim 8, further comprising applying a seasonal adjustment when determining whether the at least one parameter value for the product is above or below the at least one normalized parameter value for the category by the threshold amount.

11. A computer program product embodied on a computer readable medium, comprising:
computer code for receiving or computing at least one parameter value for a product for a first period of time, wherein the at least one parameter value includes at least one of a number, content; or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; and velocity of the product through a sales channel of the product;
computer code for receiving or computing at least one normalized parameter value for a category of the product for a second period of time;
computer code for determining whether the at least one parameter value for the product is above or below the at least one normalized parameter value for the category by a threshold amount; and
computer code for outputting an indication that the at least one parameter value for the product is above or below the at least one normalized parameter value for the category by the threshold amount.

12. A system, comprising:
hardware for receiving or computing at least one parameter value for a product for a first period of time, wherein the at least one parameter value includes at least one of a number, content, or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; and velocity of the product through a sales channel of the product;
hardware for receiving or computing at least one normalized parameter value for a category of the product for a second period of time;
hardware for determining whether the at least one parameter value for the product is above or below the at least one normalized parameter value for the category by a threshold amount; and
hardware for outputting an indication that the at least one parameter value for the product is above or below the at least one normalized parameter value for the category by the threshold amount.

13. A computer-implemented method, comprising:
receiving or computing at least one of a timeline value that is indicative of a current stage in a lifecycle of a product; a product price value; a product sentiment value, a product popularity value; and a product discount value;
computing a recommendation value for the product based on the at least one of the timeline value; the product price value; the product sentiment value; the product popularity value; and the product discount value; and
outputting an indication of the recommendation value.

14. The method of claim 13, wherein the recommendation value is computed based on the timeline value; the product price value; the product sentiment value; the product popularity value; and the product discount value.

15. The method of claim 13, wherein the recommendation value is computed based at least on the timeline value, and further comprising calculating the timeline value by:
receiving model data about a product;
receiving or computing thresholds relevant to the model data; and
computing the timeline value based on comparing the thresholds to the model data.

16. The method of claim 13, wherein the recommendation value is computed based at least on the product sentiment value, and further comprising calculating the product sentiment value by:
receiving or computing at least one parameter value for a product for a first period of time, wherein the at least one parameter value includes at least one of a number, content, or velocity of expert reviews; a number, content, or velocity of user reviews; a number, content, or velocity of news items; a number, content, or velocity of articles; a number, content, or velocity of blog entries; a number, content, or velocity of forums regarding the product; buyer data; and velocity of the product through a sales channel of the product;
receiving or computing at least one normalized parameter value for a category of the product for a second period of time;
determining whether the at least one parameter value for the product is above or below the at least one normalized parameter value for the category by a threshold amount; and
generating the product sentiment value based on the determining.

17. The method of claim 13, further comprising sending the recommendation value to a third party.

18. The method of claim 13, wherein the recommendation value is output to a user device in response to a request therefor.

19. A computer program product embodied on a computer readable medium, comprising:
computer code for receiving or computing at least one of a timeline value that is indicative of a current stage in a lifecycle of a product; a product price value; a product sentiment value, a product popularity value; and a product discount value;
computer code for computing a recommendation value for the product based on the at least one of the timeline value; the product price value; the product sentiment value; the product popularity value; and the product discount value; and
computer code for outputting an indication of the recommendation value.

20. A system, comprising:
hardware for receiving or computing at least one of a timeline value that is indicative of a current stage in a lifecycle of a product; a product price value; a product sentiment value, a product popularity value; and a product discount value;
hardware for computing a recommendation value for the product based on the at least one of the timeline value; the product price value; the product sentiment value; the product popularity value; and the product discount value; and
hardware for outputting an indication of the recommendation value.
